(19) United States
(12) Patent Application Publication
(10) Pub. No.: US 2024/0007368 A1
(43) Pub. Date: Jan. 4, 2024

(54) VISUALIZATION OF DATA MESSAGE TRAVERSAL ACROSS SERVICES

(71) Applicant: VMware, Inc., Palo Alto, CA (US)

(72) Inventors: Shrinivas Sharad Parashar, Pune (IN); Tarang Khandelwal, Pune (IN); Pritesh Ramesh Gajjar, Pune (IN); Pavan Vaidyula, Pune (IN); Trisha Shah, Pune (IN)

(21) Appl. No.: 17/852,820

(22) Filed: Jun. 29, 2022

(51) Int. Cl. H04L 43/045; H04L 43/10; G06T 13/80; G06F 3/04847; G06F 3/0482

(52) U.S. Cl. CPC H04L 43/045; H04L 43/10; G06T 13/80; G06F 3/04847; G06F 3/0482; G06T 2200/24; G06F 2203/04803

(57) ABSTRACT

Some embodiments provide a method that provides a visualization of data message paths through sets of services. For each data message of multiple data messages that traverse a network, the method identifies a set of services applied to the data messages within the network based on flow data collected from a set of network elements. The method generates an animated visualization of the data messages that includes representations of the services and paths the data messages take through the services. The method provides the generated visualization in a graphical user interface (GUI) to enable monitoring of data messages traversing the network via different service paths.

### BACKGROUND

Within datacenter networks, many layers of services (e.g., firewalls, intrusion detection/prevention, anti-malware, etc.) are often applied to packets. This can make it difficult for a security administrator to troubleshoot all of these services (e.g., identifying where packets are dropped or blocked and why, or why certain packets were not dropped or blocked). To perform this troubleshooting, an administrator typically has to manually collect and relate this information from the various different services spread across the system. As such, better techniques for automating this troubleshooting would be useful.

### BRIEF SUMMARY

Some embodiments provide a novel method for displaying an animated visualization to enable monitoring of data messages traversing a network. For each of a set of data messages that traverse the network, a monitoring application identifies any services applied to the data messages within the network based on data collected from a set of network elements (e.g., gateway devices, host computers that execute forwarding elements and/or middlebox service elements, etc.). The monitoring application generates an animated visualization of the data messages that includes representations of the services and paths the data messages take through the services and provides the generated visualization in a graphical user interface (GUI) to enable monitoring of data messages traversing the network via different service paths.

In some embodiments, the data collected from the set of network elements may be collected and stored by any component in the network (e.g., hosts, gateway devices, etc.). The data may include flow data regarding the flows traversing through the network and configuration data of components within the network. The data may be collected and stored for any specified period of time for use in generating the animated visualization. Methods and systems regarding collection and storage of data is further described in U.S. Patent Publication 2021/0029050, which is incorporated by reference in this application.

In some embodiments, the animated visualization generated from this flow and/or configuration data includes an animated heatmap that indicates (1) when a particular service is processing a high load of data messages and (2) when a high load of data messages is sent on a particular path between a pair of services. In different embodiments, the determination as to whether a service or path has a high load of data messages may be determined based on an absolute count of the number of data messages, based on a number of data messages relative to an average, or in other manners.

The GUI, in some embodiments, includes a number of features that enable a user to view animation of a specific set of data messages and/or view additional information about the data messages represented in the visualization. The animated visualization is in some embodiments a visualization of data messages that traverse the network over a certain period of time. The GUI may include a selectable item enabling a user to modify this period of time such that, when the user selects a new period of time, the method generates a new animated visualization of the data messages that traversed the network during the new period of time. For instance, if the user selects the period of time to be the last 24 hours, the GUI would generate an animated visualization that includes data messages traveling through the network within the last 24 hours. If the user selects the period of time to be a particular previous week, the animated visualization would only include data messages traveling through the network during that particular week.

In some embodiments, the GUI includes a set of filters for a user to select sets of characteristics of the data messages represented in the visualization. Upon selection of a set of data message characteristics via the set of filters, the method generates a new animated visualization that includes representations of only data messages that match the selected set of data message characteristics. The data message characteristics that may be selected in some embodiments may include any of the tuples in a five tuple identifier (e.g., source network address, destination network address, source transport layer port number, destination transport layer port number, and transport protocol). For example, the user may select destination network address and source transport layer port number so the new animated visualization only includes data messages with the selected destination network address and source transport layer port number. One of ordinary skill would understand that any other data message characteristic (e.g., data link layer addresses, layer 5-7 information, etc.) may be used as a filter for the animated visualization.

The GUI may also include a set of selectable items for identifying, for inclusion in the animated visualization, one of (1) data messages entering the network (i.e., ingress traffic), (2) data messages exiting the network (i.e., egress traffic), and (3) data messages with its source and destination within the network (i.e., intra-application traffic). For example, the user may use this set of selectable items to include only intra-application traffic in the animated visualization such that only data messages being sent between virtual machines (VMs) within the network will be shown in the visualization. Some embodiments require the user to select only one of these types of traffic for visualization at a time (e.g., using radio buttons) while other embodiments allow the user to select more than one type of traffic for inclusion in the visualization.

In some embodiments, the GUI may include a set of selectable items for identifying, for inclusion in the animated visualization, one or more of (1) allowed data messages, (2) dropped data messages, and (3) blocked (i.e., rejected) data messages. For instance, a user may use this set of selectable items to include data messages that were allowed by each service they passed in their paths in the animated visualization. The user may also include data messages that were dropped and/or blocked at one of the services included in their service paths. Of these selectable items, the user may select one or more of the selectable items to view one or more of these types of data messages in the animated visualization.

In addition to the animated visualization, the GUI of some embodiments may include a set of display areas for displaying representations of groups of data messages having different sets of selectable characteristics. The display areas may include separate display areas for each of allowed data messages, dropped data messages, and blocked data messages. The selectable characteristics for grouping the data messages may include a five tuple identifier (e.g., source network address, destination network address, source transport layer port number, destination transport layer port number, and transport protocol). A user may select one or more of the selectable characteristics to use as the set of characteristics for grouping data messages within the set of display areas. For instance, a user may select source network address, such that the display areas show groups of data messages that are grouped by their source network addresses. Within the display areas, the GUI will display data messages grouped based on having a same source network address and based on whether the data messages were allowed, dropped, or blocked. Alternatively, a user may select source network address and destination network address, such that the display areas show groups of data messages that are grouped by their source and destination network addresses. Within the display areas, the GUI will display data messages grouped based on having a same source network address and a same destination network address, and based on whether the data messages were allowed, dropped, or blocked.

In some embodiments, each of group of data messages that has a same set of values for the selected characteristics is represented using a selectable item. Each of these selectable items may vary in size based on the number of data messages in the group that represents the selectable item. For instance, a group of five data messages will have a larger represented selectable item than a group of two data messages. Upon selection of one of these selectable items, the GUI displays additional information about the group of data messages represented by the selected selectable item. For instance, upon selection of a particular selectable item representing a particular group of data messages, the GUI displays additional information about that group, such as one or more of (1) the number of data messages in the group, (2) an action taken on each data message in the group (e.g., allow, drop, block, etc.), (3) a source network address of each data message in the group, (4) a destination network address of each data message in the group, (5) a source port of each data message in the group, (6) a destination port of each data message in the group, and (7) a protocol of each data message in the group.

In some embodiments, through the animated visualization, the monitoring application receives a selection of a particular data message. In response to the selection, the method displays in the GUI (1) a set of characteristics of the selected data message, (2) a path through a set of services of the network traversed by the selected data message, (3) information regarding additional data messages sharing at least a subset of the set of characteristics of the selected data message, and (4) information regarding one or more service rules applied to the data message at one or more of the services.

The set of characteristics of the selected data message that is displayed in the GUI may include a five tuple identifier (e.g., source network address, destination network address, source transport layer port number, destination transport layer port number, and transport protocol) for the selected data message. The path through the set of services displayed in the GUI may specify each of the services that processed the data message as well as a timestamp at which the data message was processed by each of the services on the path. For instance, the GUI may specify three timestamps at which the selected data message was processed by three particular services on the selected data message's path. The information regarding the additional data messages may specify, for each additional data message displayed, at least one of (1) a source network address of the additional data message, (2) a destination network address of the additional data message, and (3) an application to which the additional data message is related.

In some embodiments, the GUI may also indicate whether the selected data message was allowed, dropped, or blocked. For instance, the GUI may display that the data message was allowed by each of the services that processed the data message. Alternatively, the GUI may display that the data message was dropped or blocked at a particular service that processed the data message (e.g., with a timestamp that the data message was dropped or blocked). The GUI may also display information regarding one or more service rules that were applied to the selected data message at the one or more services that processed the data message. The information displayed in the GUI regarding these service rules may indicate, for each displayed rule, a name for the rule and a service policy to which the rule belongs. The GUI may also display information that indicates an action taken on the data message based on the application of the service rule. For example, if the selected data message was rejected at a particular service, the GUI of some embodiments displays (1) the rule name for the rule that was used by the particular service to reject the data message, (2) the service policy to which that rule belongs, and (3) that the data message was rejected. If the selected data message was allowed and was processed by two services, the GUI displays (1) the rule names, (2) the corresponding service policies that were used to allow the data message, and (3) that the data message was allowed.

In some embodiments, the application also displays in the GUI, for each service rule for which information is displayed, a selectable item for enabling a user to view modifications previously made to the service rule. Upon receiving a selection of this item for a particular service rule, the application may display a set of modifications previously made to the selected particular service rule. For example, if the GUI displays a service rule that rejected the data message, the user may select the selectable item to view modifications that have been previously made to that service rule. In response, for each different time the particular service rule was modified, the GUI displays a timestamp for the modification and a set of attributes of the service rule that was modified.

Within this displayed set of modifications, the GUI of some embodiments also includes a selectable item for selecting a particular period of time such that the set of modifications displayed are within the particular period of time. For instance, if the service rule has been changed twice in the last 24 hours, and if the user selects the selectable item to view modifications within the last 24 hours, the displayed set of modifications would include those two modifications to the service rule. The displayed set of modifications may also include a selectable item for viewing, in more detail, one or more of the modifications to the particular service rule. Upon receiving selection of a set of modifications and the selectable item for viewing modifications to the particular service rule, the GUI then displays information regarding the selected modifications to the particular service rule. For example, the user may select two modifications made to the service rule to view in more detail the set of attributes changed during those two modifications. The user may use this information to compare the two modifications to the service rule.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an example architecture of a network in which some embodiments of the invention are implemented.

FIG. 2 conceptually illustrates a process of some embodiments to generate a visualization in a GUI of data messages traversing different service paths in a network.

FIGS. 3A-B illustrate an example GUI including an animated visualization of data messages traversing different services in a network in two stages with various selectable items.

FIG. 4 illustrates an example GUI including an animated visualization with additional information regarding a particular data message selected by a user.

FIGS. 5A-B illustrate an example GUI including an animated visualization with an animated heatmap in two stages.

FIG. 6 illustrates an example GUI including an animated visualization with various selectable items to group different data messages and to view additional information.

FIG. 7 conceptually illustrates a process of some embodiments to display information regarding a data message.

FIG. 8 illustrates an example GUI displaying information regarding a selected data message and service rules applied to the data message.

FIGS. 9A-B illustrate an example GUI displaying information regarding modifications made to a selected service rule.

FIG. 10 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel method for displaying an animated visualization to enable monitoring of data messages traversing a network. For each of a set of data messages that traverse the network, a monitoring application identifies any services applied to the data messages within the network based on data collected from a set of network elements (e.g., gateway devices, host computers that execute forwarding elements and/or middlebox service elements, etc.). The monitoring application generates an animated visualization of the data messages that includes representations of the services and paths the data messages take through the services and provides the generated visualization in a graphical user interface (GUI) to enable monitoring of data messages traversing the network via different service paths.

In some embodiments, the data collected from the set of network elements may be collected and stored by any component in the network (e.g., hosts). The data may include flow data regarding the flows traversing through the network and configuration data of components within the network. The data may be collected and stored for any specified period of time for use in generating the animated visualization.

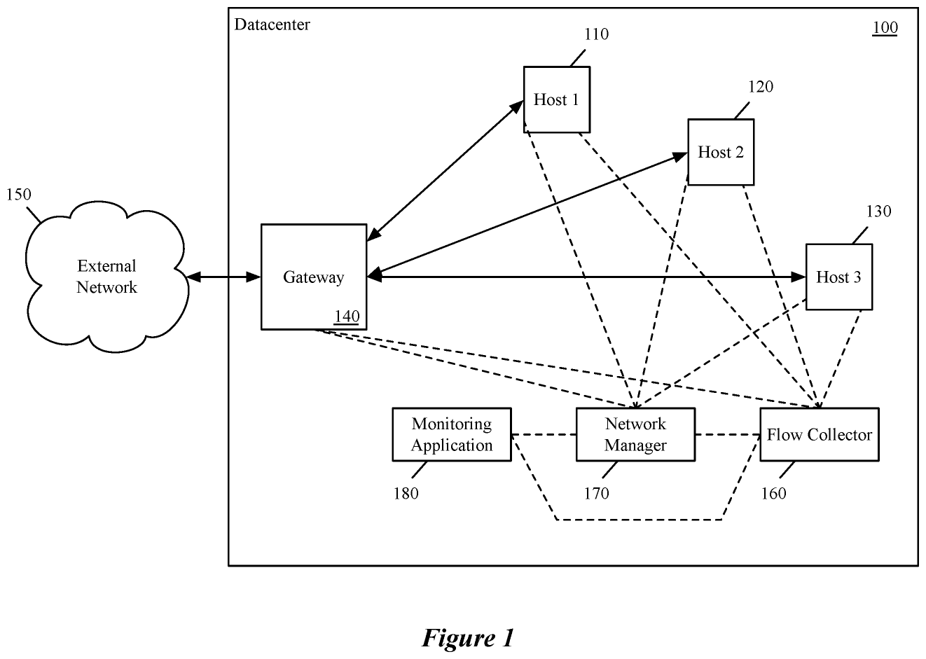

FIG. 1 illustrates an example architecture in which some embodiments are implemented. In a datacenter network 100, data compute nodes (e.g., virtual machines, containers, etc.) executing on hosts (e.g., hosts 110-130) communicate with one another through a physical network infrastructure (not shown) as well as with external endpoints via a set of one or more gateway devices 140. Each host 110-130 may execute any number of virtual machines (VMs) or other data compute nodes (DCNs) that send traffic to the other VMs on the same host or on other hosts. Each host may also communicate with an external network 150 via the gateway device 140. In some embodiments, traffic sent from the external network 150 to any host in the network 100 is considered incoming traffic, traffic sent from any host in the network 100 to the external network 150 is considered outgoing traffic, and traffic sent from one host to another within the network 100 is considered intra-application traffic. it should be noted that any number of hosts, gateways, and other devices may be part of the network 100.

In some embodiments, the network 100 may include a flow collector 160 for collecting and storing information regarding incoming, outgoing, and intra-application flows throughout the network. The flow collector 160 may monitor each host and gateway to identify flow information and subsequently store this information. In some embodiments, each of the hosts 110-130 as well as the gateway device 140 executes a set of collection modules (e.g., introspection agents operating within the VMs, collectors operating within the virtualization software of the hosts) that collect flow data and/or context data and provide this information to the flow collector 160.

The network manager 170, in some embodiments, represents a network management and control system that manages the datacenter network 100. In different embodiments, the network management and control system may include one or more network managers and/or network controllers. The network manager 170 defines network configuration data for the hosts 110-130 and the gateway device 140 based on network configurations received from one or more administrators (e.g., to define one or more logical networks in the datacenter) and provides this configuration data to the hosts 110-130 and the gateway 140. This network configuration data may include forwarding (e.g., switching and/or routing) rules as well as rules for various services (e.g., distributed firewall rules, gateway firewall rules, network address translation rules, intrusion detection/prevention service rules, load balancing rules, etc.). The collection and storage of flow and/or context data is further described in U.S. Patent Publication 2021/0029050, which is incorporated by reference herein.

The network 100 also includes a monitoring application 180. This application may execute on the same computer as the flow collector 160 and/or the network manager 170 or may execute on a standalone computer. The monitoring application 180 uses the flow information collected by the flow collector 160 as well as configuration information from the network manager 170 to generate a GUI to display this information to a user. A user may interact with this GUI using various selectable items to view different information regarding data messages traversing the network 100, services that process these data messages, and rules applied to data messages at each of the services.

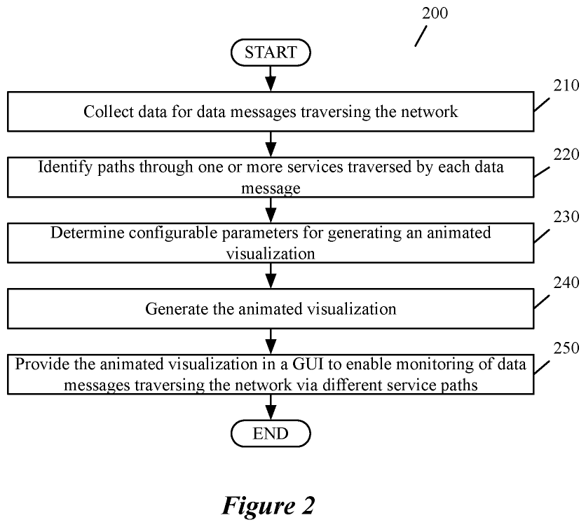

FIG. 2 conceptually illustrates a process 200 of some embodiments for generating an animated visualization in a GUI of data messages traversing a set of services of a network. This process may be performed by a monitoring application in a network in some embodiments. The following example will be described with reference to the monitoring application 180 of FIG. 1, but it should be understood that the process 200 may be performed by any monitoring application in any network with any configuration of hosts, gateway devices, etc.

The process 200 begins by collecting (at 210) data for data messages traversing a network. In some embodiments, the monitoring application 180 collects the data from the flow collector 160. In other embodiments, the monitoring application 180 may collect this data itself. The collected data may be for incoming, outgoing, and intra-application data messages. The collected data for each data message may include the data message's five tuple identifier (e.g., source network address, destination network address, source transport layer port number, destination transport layer port number, and transport protocol). The collected data may also include, for each data message, (1) which services processed the data message, (2) a timestamp for each identified service specifying the time the service processed the data message, and (3) the action taken by each service that processed the data message (i.e., whether the service allowed, dropped, or blocked the data message). One of ordinary skill would understand that any characteristics related to data messages traversing a network may be included as the collected data.

Next, the process 200 identifies (at 220) paths through one or more services traversed by each data message for which data was collected. Using the collected data, the monitoring application 180 of some embodiments may identify information regarding each service path traversed by each data message. For example, for a particular data message, the monitoring application 180 may identify from the collected data (1) a set of services that processed the particular data message as it traversed the network, (2) specific service rules that each service applied to the data message, (3) timestamps for each service specifying when the service processed the particular data message, and (4) actions applied to the data message based on each applied service rule.

The services, in different embodiments, may include firewall services (e.g., gateway firewall service and/or distributed firewall service, intrusion detection/prevention service, load balancer services, network address translation service, etc.). In some embodiments, each service that processes a data message applies one or more rules that either allows, drops, or blocks (rejects) the data message. In some embodiments, the timestamp recorded may be the time when the particular data message was received at the service. In other embodiments, the timestamp recorded may be the time the service finished processing the particular data message. The process 200 may identify all of this type of information from the collected data for all data messages traversing the network.

Next, the process 200 determines (at 230) configurable parameters for generating an animated visualization. Examples of the configurable parameters may be (1) a time filter to specify that the visualization only show data messages that traversed the network within a particular time period, (2) data message characteristic filters to specify one or more data message characteristics (e.g., source network address, destination network address, etc.) such that the visualization only displays data for data messages matching those characteristics, (3) a type of traffic filter to specify which types of traffic (incoming, outgoing intra-application) to be represented in the visualization, and (4) action filters to specify one or more action types (e.g., allow, drop, reject) such that the visualization only shows data messages to which the selected action was ultimately applied. One of ordinary skill would understand that any characteristics related to data messages traversing a network may be included as configurable parameters to use to generate the visualization.

In some embodiments, the determined configurable parameters may be default parameters set by an administrator or a user. For instance, the default configurable parameters may include (1) all data messages traversing the network for any specified period or length of time (e.g., all data messages within the last 24 hours), (2) all data messages with any characteristics, (3) any type of traffic, and (4) any action type taken on data messages. The default configurable parameters may also be as restrictive as an administrator or user may specify. In some embodiments, the configurable parameters may be continuously changed/updated by a user through the GUI. For instance, if an animated visualization is currently being displayed and the user inputs new configurable parameters for any filters or selectable items included in the GUI, the monitoring application 180 may use these new configurable parameters input by the user to generate an updated animated visualization according to the new configurable parameters. The configurable parameters will be described in more detail below.

The process 200 then generates (at 240) the animated visualization. In some embodiments, the monitoring application 180 generates the animated visualization to visually represent the services and service paths taken by the data messages traversing the network. The process 200 provides (at 250) the generated animated visualization in a GUI to enable monitoring of data messages traversing the network via different service paths. As will be described further below, the animated visualization includes an animation of the data messages traversing the different services and selectable items for the user to select to view more information and alter the animation.

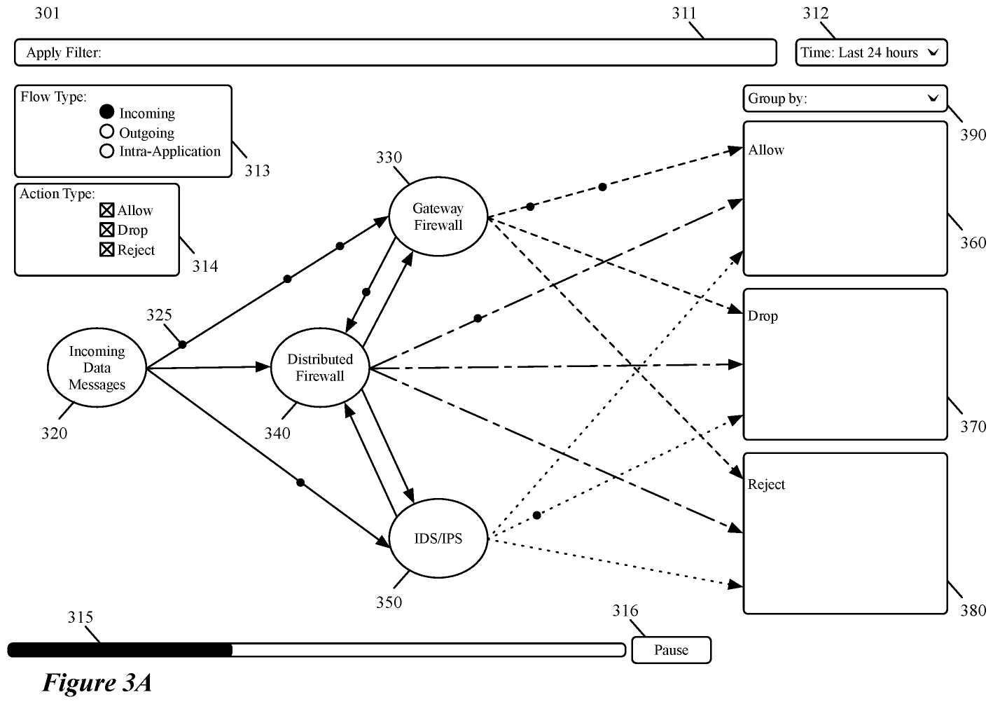

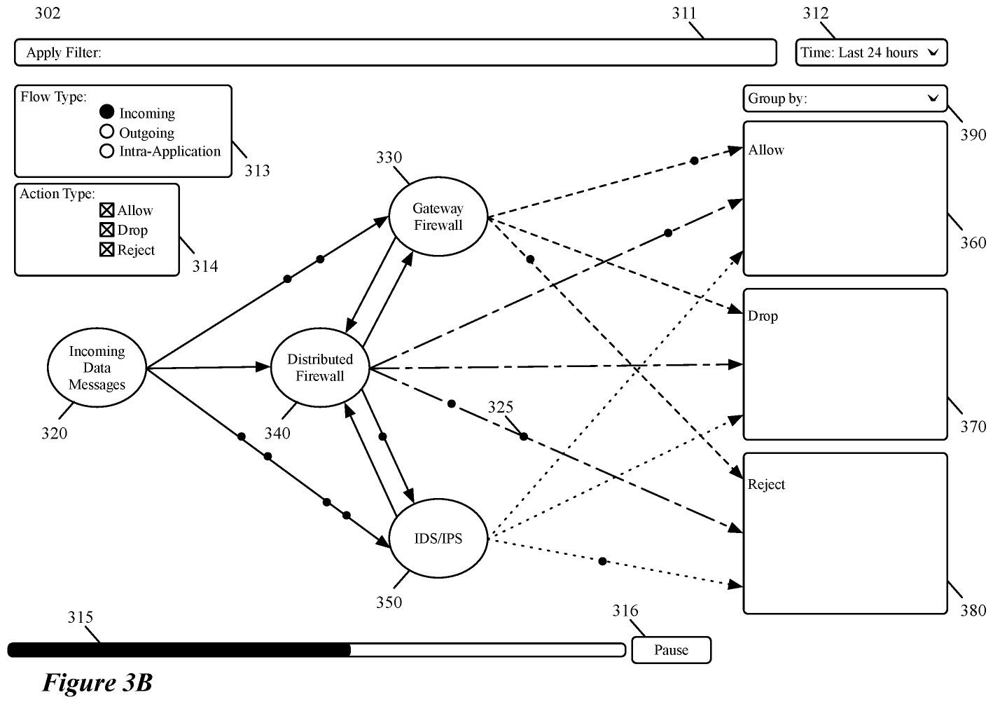

FIGS. 3A-B show an example animated visualization in a GUI in two stages. The GUI, in some embodiments, includes a number of features that enable a user to view animation of a specific set of data messages and/or view additional information about the data messages represented in the visualization. Both stages 301, in FIG. 3A, and 302, in FIG. 3B, illustrate the filters and selectable items displayed in the GUI for the user.

The GUI of some embodiments includes an “Apply Filter” 311 for the user to select and filter different data message characteristics. A user may use this filter such that the animated visualization only includes data messages with the specified characteristics. Examples of data message characteristics include any of the tuples in a five tuple identifier (e.g., source network address, destination network address, source transport layer port number, destination transport layer port number, and transport protocol). For example, the user may select that only data messages associated with a particular protocol are to be included. The user may also select that only data messages associated with the particular protocol and a source network address to be included. One of ordinary skill would understand that any other data message characteristic (e.g., data link layer addresses, layer 5-7 information, etc.) may be used in this filter 311 for the animated visualization. Upon selection of data message characteristics via the “Apply Filter” 311, a new animated visualization may be generated with representations of only data messages that match the selected data message characteristics.

In some embodiments, the GUI also includes a time filter 312 for displaying the animated visualization of data messages that traverse the network over a certain period of time. This selectable item 312 enables a user to modify this period of time such that, when the user selects a new period of time, a new animated visualization is generated for the data messages that traversed the network during the new period of time. In the example of FIGS. 3A-B, the selected period of time is the last 24 hours. If a user uses the selectable item 312 to select the period of time to be a particular previous week, the animated visualization would then only include data messages traveling through the network during that particular week.

The GUI may also include a set of “Flow Type” selectable items 313 for the user to view and select which type of traffic to include in the animated visualization. These selectable items 313 may enable a user to identify one of (1) data messages entering the network (i.e., ingress or incoming traffic), (2) data messages exiting the network (i.e., egress or outgoing traffic), and (3) data messages with both source and destination within the network (i.e., intra-application traffic) to use in the animated visualization. For example, the user may select intra-application traffic such that only data messages being sent between VMs within the network will be shown in the visualization. Some embodiments require the user to select only one of these types of traffic for visualization at a time (e.g., using radio buttons) while other embodiments allow the user to select more than one type of traffic for inclusion in the visualization. In the example of FIGS. 3A-B, the flow type filter 313 has incoming traffic selected, as denoted by a filled in radio button, and the animated visualization includes data messages incoming to the network (e.g., from an external network such as external network 150).

The GUI may also include, in some embodiments, an “Action Type” filter 314 with selectable items to view different data messages in the visualization. A user may use these selectable items to view one or more of (1) allowed data messages, (2) dropped data messages, or (3) blocked/rejected data messages in the animated visualization. For instance, a user may use this set of selectable items 314 to include data messages that were allowed by each service they passed in their paths in the animated visualization. The user may also include data messages that were dropped and/or blocked at one of the services included in their service paths. Of these selectable items, the user may select one or more of the selectable items to view one or more of these types of data messages in the animated visualization. In this example, all three selectable items are selected, as denoted by an “X” in each box. The animated visualization hence includes data messages with each of these action types as the final action taken on the data messages (i.e., the action taken by the last service to process the data message).

In some embodiments, the GUI also includes a progress bar 315, which shows the progression of the animated visualization. Stage 301 in FIG. 3A shows the progress bar 315 at an earlier stage than the progress bar 315 in stage 302 in FIG. 3B. The GUI may also include a play/pause selectable item 316 for a user to pause and play the animation.

In FIGS. 3A-B, incoming packets are selected for display in the animated visualization, as denoted by the set of selectable items 313. The animated visualization therefore displays incoming packets 320 as the start of the paths. In some embodiments, the animated visualization does not display the sources and destinations of each data message and only displays the services that process the data messages. The three services displayed in this example GUI are a gateway firewall 330, a distributed firewall 340, and an Intrusion Detection System (IDS)/Intrusion Prevention System (IPS) 350. It should be noted that any number and any type of service, such as any middlebox service, may be included in the network and may be displayed in the GUI. The GUI may display arrowed lines from the incoming packets 320 to any of the displayed services and between any of these services to denote paths taken by different data messages. For instance, in FIGS. 3A-B, solid arrowed lines are shown as paths taken by different data messages. Data messages in this example are denoted by black dots, such as data message 325 which, at stage 301, is being sent to the gateway firewall 330.

The GUI may also include arrowed lines from each service to various “Action” windows displayed in the GUI to show data messages and the final action taken by the final service that processed them. For example, (1) data messages being allowed at the gateway firewall and sent to their destinations follow the dotted arrowed line from the gateway firewall 330 to the “Allow” window 360, (2) data messages being dropped at the gateway firewall follow the dotted arrows line from the gateway firewall 330 to the “Drop” window 370, and (3) data messages being rejected at the gateway firewall follow the arrowed dotted line to the “Reject” window 380. Similar dotted lines are also drawn for the distributed firewall 340 and IDS/IPS 350. At stage 301, two data messages are being allowed at the gateway firewall 330 and sent to their destinations, one data message is being allowed at the distributed firewall 340 and sent to its destination, and one data message is being dropped at the IDS/IPS 350.

At stage 302 which shows the animated visualization at a further progression than stage 301, the data message 325 has moved past the gateway firewall 330 and is being rejected by the distributed firewall 340. The data message 325 is on its way to the “Reject” window 380. The “Reject” window 380, along with the “Allow” window 360 and the “Drop” window 370, may in some embodiments be a set of display areas for displaying representations of groups of data messages having different sets of selectable characteristics. Using the “Group” selectable item 390, a user may select one or more data message characteristics to display data message groups in these windows 360, 370, and 380. Information regarding displaying groups in the GUI will be described further below.

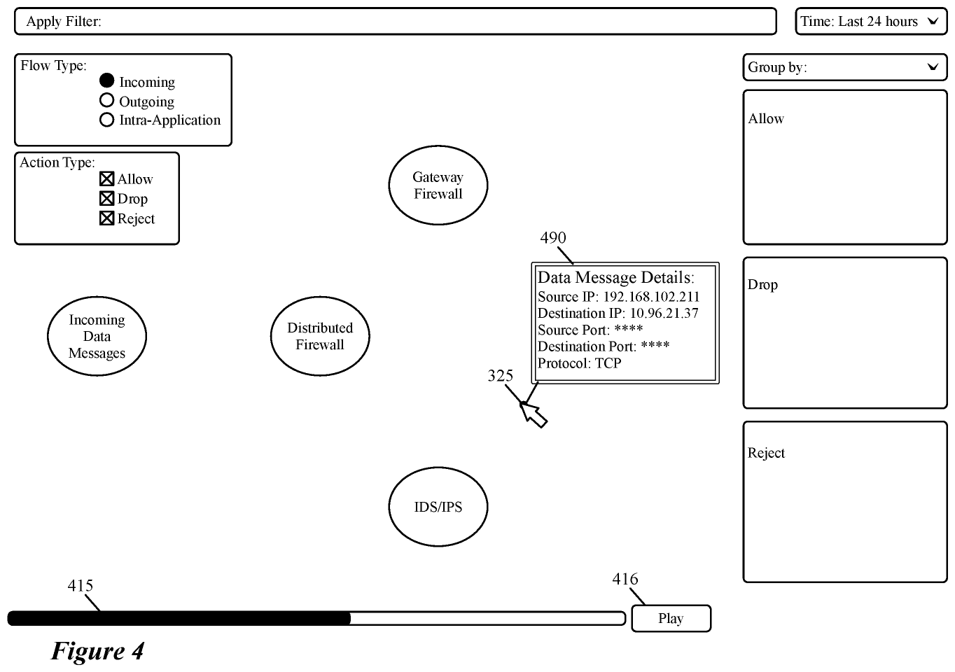

FIG. 4 illustrates an example GUI in a paused state at the same progression of the animated visualization as FIG. 3B, as denoted by the progress bar 415 and the “play/pause” button 416. In this figure, a user has hovered a mouse over the data message 325. In doing so, the GUI may remove all other displayed data messages and all arrows in the visualization and display information 490 regarding the data message 325. In some embodiments, this additional information 490 about the data message may include any of the tuples in the data message's five tuple identifier, which is shown in this figure. The additional information may display, instead or in addition to the five tuple identifier, any information regarding the data message.

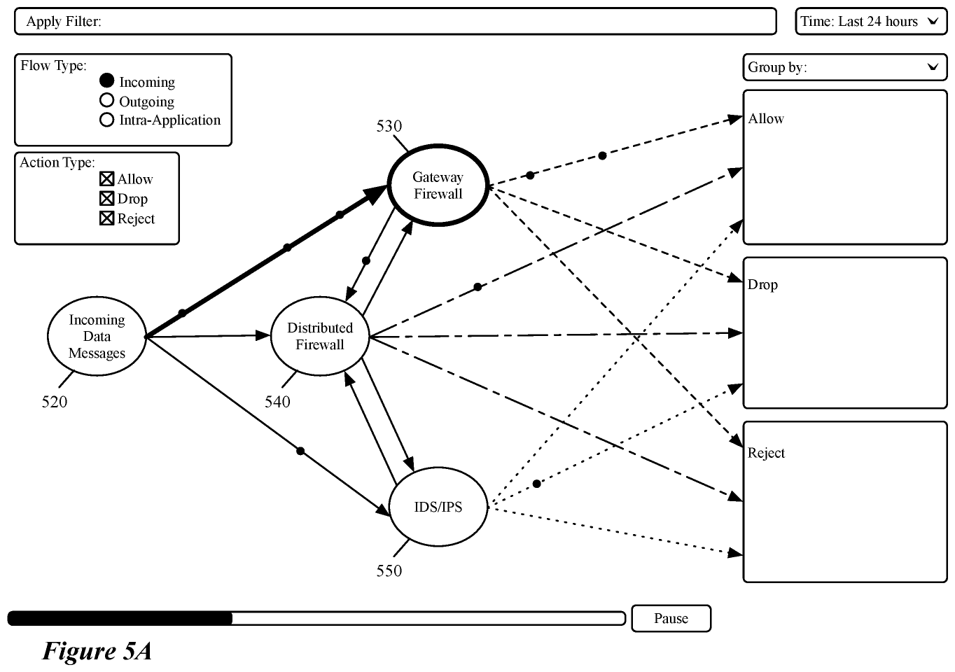

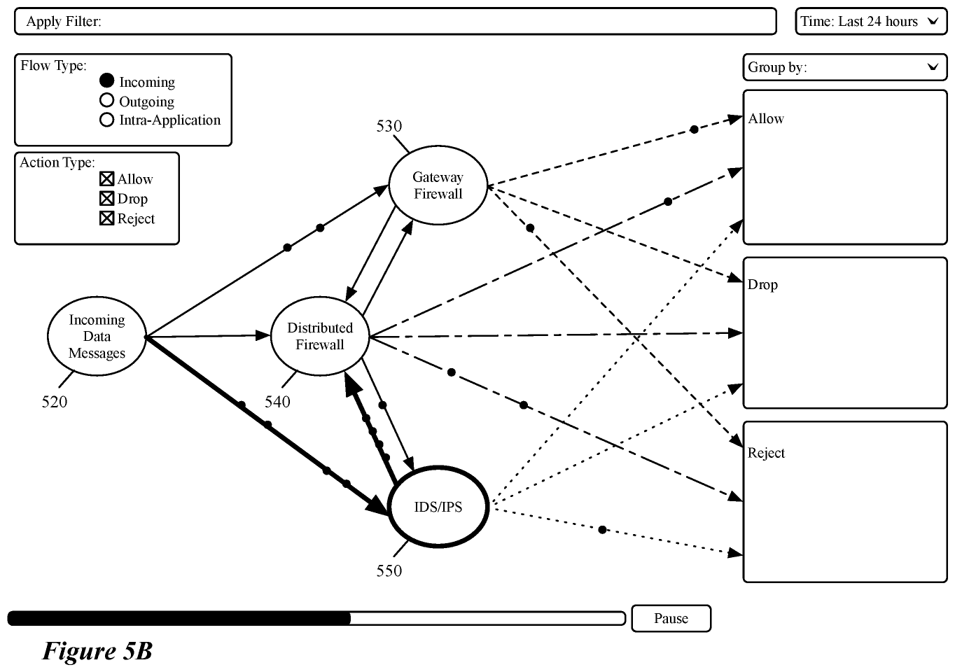

FIGS. 5A-B illustrate another example GUI displaying the services and service paths traversed by data messages in a network. In this example, the animated visualization also displays an animated heatmap that indicates (1) when a particular service is processing a high load of data messages and (2) when a high load of data messages is sent on a particular path between a pair of services. In FIG. 5A, the heatmap indicates a high load of incoming data messages 520 being sent to and processed at the gateway firewall 530, as denoted by a thicker black arrowed line than lines pointing to the distributed firewall 540 and the IDS/IPS 550. In FIG. 5B, showing the animated visualization at a further progression, the heatmap indicates a high load of incoming data messages 520 being sent to the IDS/IPS 550, a high load of data messages being processed by the IDS/IPS 550, and a high load of data messages being sent from the IDS/IPS 550 to the distributed firewall 540. This figure also indicates that the gateway firewall 530 is processing a lower load of data messages than in FIG. 5A.

In different embodiments, the determination as to whether a service or path has a high load of data messages may be determined based on an absolute count of the number of data messages, based on a number of data messages relative to an average, or in other manners. A high load of data messages associated with the animated heatmap may be relative to an absolute value in a particular period of time, e.g., 500 data messages in 0.5 seconds. For example, if a particular service is receiving 300 data messages in 0.5 seconds, the animated heatmap would indicate a higher load on the service than if the service was receiving 100 data messages in 0.5 seconds. Alternatively, a high load may be relative to a mean, or average, value. For example, if the mean value for data messages passing from a first service to a second service is 100 data messages per second, and, at a particular point in time, 200 data messages were travelling from the first service to the second service in one second, the heatmap would indicate this high load of data messages traveling from the first to the second service.

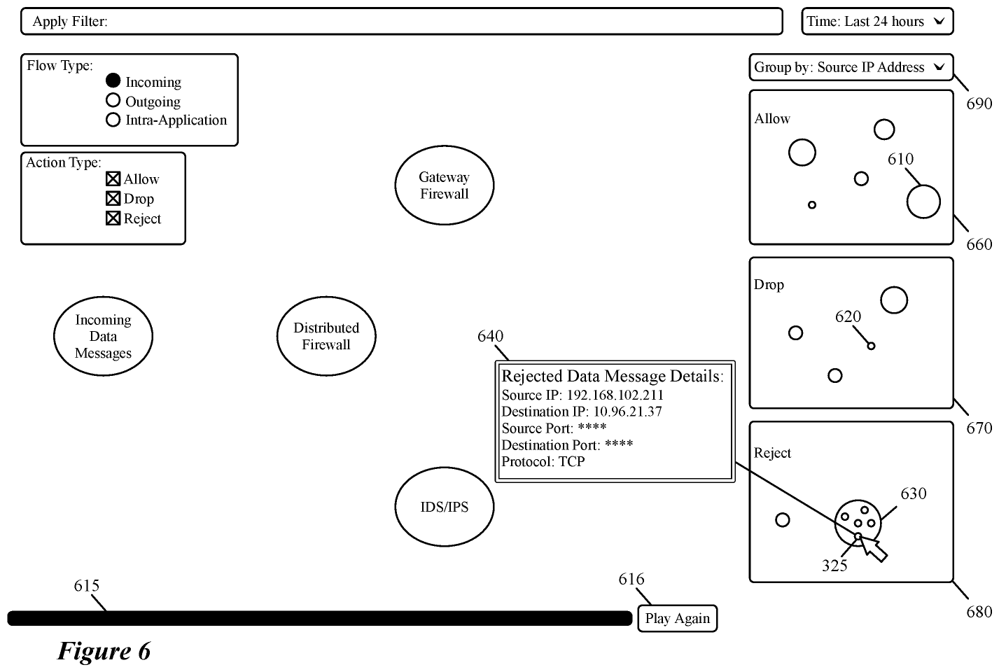

FIG. 6 illustrates an example GUI at the end of the animated visualization, as denoted by the progress bar 615 and “play/pause” button 616. While this GUI is illustrated at the end of the animated visualization, all other information displayed in this GUI may be displayed at any point during the animated visualization. In FIG. 6, a user has selected a data message characteristic via the “Group” selectable item 690. The selectable characteristics for grouping the data messages may include a five tuple identifier or any other suitable data message characteristic. A user may select one or more of the selectable characteristics to use as the set of characteristics for grouping data messages within the set of display areas.

In this example, a user has selected that data messages in the “Action” windows 660, 670, and 680 be grouped by their source internet protocol (IP) address. In each “Action” window, a selectable item for each group is shown. For example, the selectable item 610 represents a group of allowed data messages sharing the same source IP address, and the selectable item 620 represents a group of dropped data messages with the same source IP address. In some embodiments, the selectable items representing the groups may vary in size based on the number of data messages in the group that represents each selectable item. For instance, a group of five data messages will have a larger represented selectable item than a group of two data messages. In this example, the selectable item 610 is larger than the selectable item 620, indicating that there are more data messages in the group represented by the selectable item 610 than there are in the group represented by the selectable item 620.

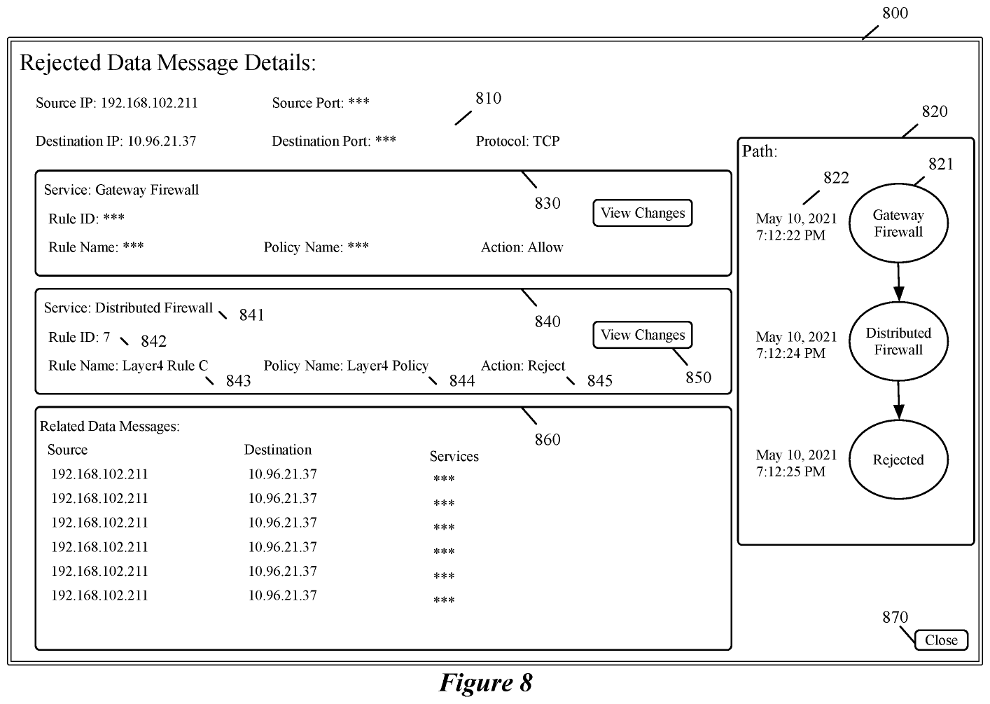

In some embodiments, a user may hover a mouse over or select a selectable item representing a group to view representations of each data messages in the group and to view additional information about the group. For instance, upon selection of a particular selectable item representing a particular group of data messages, the GUI displays additional information about that group, such as one or more of (1) the number of data messages in the group, (2) an action taken on each data message in the group (e.g., allow, drop, block, etc.), (3) a source network address of each data message in the group, (4) a destination network address of each data message in the group, (5) a source port of each data message in the group, (6) a destination port of each data message in the group, and (7) a protocol of each data message in the group. The user may also hover over or select a particular data message within a particular group to view additional information regarding that data message. In this example, a user hovers a mouse over the selectable item 630 to view five data messages in the group and hovers the mouse over the data message 325 (which was rejected by the distributed firewall service, as shown in FIG. 3B) to view information about this data message in the information window 640. This information window 640 may display any information associated with the data message 325. In some embodiments, a user selection of the data message 325 will enable the GUI to display a new window, as shown in FIG. 8. Information regarding this GUI will be described further below.

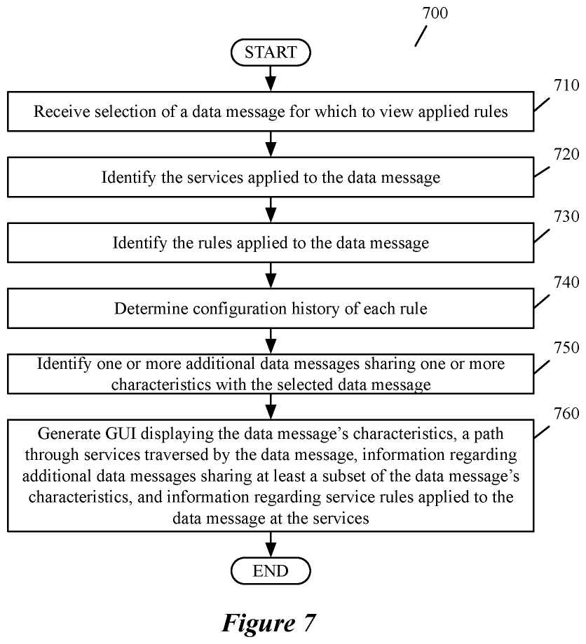

FIG. 7 conceptually illustrates a process 700 of some embodiments to generate a GUI displaying information associated with a data message. This process may be performed by a monitoring application in a network. The following example will be described with reference to the monitoring application 180 of FIG. 1 and the GUI of FIG. 6, but it should be understood that the process 700 may be performed by any monitoring application in any network with any GUI displaying information regarding data messages traversing a network.

The process 700 begins by receiving (at 710) a selection of a data message for which to view applied rules. In some embodiments, the monitoring application 180 receives this selection from a user through the GUI. In the example of FIG. 6, the user may select the rejected data message 325 shown in the rejected group 630 to view the rules that were applied to the data message 325 at each service that processed it. The user could also select any of the other rejected data messages as well as the dropped or allowed data messages.

Next, the process 700 identifies (at 720) the services applied to the data message. These services will be the same services through which the animation shows the selected data message flowing. For instance, for the rejected data message 325, the process 700 identifies the gateway firewall and the distributed firewall as the services that were applied to the data message 325.

The process 700 also identifies (at 730) the rules applied to the data message. For the data message 325, the process 700 identifies the rules that were used at the gateway firewall and the distributed firewall to process the data message 325. In some embodiments, one rule is applied at each of the services that process the data message. In other embodiments, some of the service might apply multiple rules in succession, each of which are identified.

The process 700 also determines (at 740) the configuration history of each rule. For example, the process 700 may determine changes that have been made to each identified rule and when those changes were made. The process may also identify (at 750) additional data messages sharing at least a subset of the set of characteristics of the selected data message. For instance, the process 700 may identify any data messages that traversed the network sharing one or more characteristics with the selected data message 325, and any services that processed those data messages. In some embodiments, the monitoring application 180 identifies all of this information via data collected by the flow collector 160 as well as configuration data from the network manager 170. In other embodiments, the monitoring application 180 identifies this information itself.

The process 700 then generates (at 760) a GUI displaying (1) a set of characteristics of the selected data message, (2) the path through the services traversed by the selected data message, (3) information regarding the additional data messages sharing at least a subset of the selected data message's characteristics, and (4) information regarding service rules applied to the selected data message at the services. In the example of the data message 325, the GUI may display this data message's characteristics, the data message's path through the gateway firewall and the distributed firewall, information regarding other data messages sharing characteristics with the data message 325, and information regarding the service rules that were applied to the data message 325 at the gateway firewall and the distributed firewall.

FIG. 8 illustrates an example GUI 800 displaying the information discussed for process 700. This GUI 800 displays the details for the rejected data message 325 after being selected by a user using the GUI in FIG. 6. The data message characteristics are displayed at 810. The data message's five tuple identifier is displayed for the data message 325, however, in different embodiments, any characteristics relating to a data message may be displayed. The GUI 800 also displays in the window 820 the path 821 traversed by the data message 325. The path 821 shows that the data message 325 was processed by the gateway firewall and the distributed firewall, and subsequently rejected. The window 820 also displays a timestamp 822 for each part of the displayed path 821. The timestamps 822 in some embodiments indicate when each of the services received or processed the data message, and when the final action was applied to the data message (e.g., when the data message was allowed to travel to its destination, dropped, or rejected/blocked).

The GUI 800 also displays, for each service displayed in the path 821, windows displaying information for the service rules applied at each service. The window 830 displays information for the service rule applied at the gateway firewall, and the window 840 displays information for the service rule applied at the distributed firewall. A GUI in different embodiments may display one or more windows for one or more service rules that were applied to the selected data message. In each window 830 and 840, the GUI 800 may display in some embodiments the service at which the rule was applied 841, the rule identifier (ID) 842, the rule name 843, the policy name 844 of the service policy to which the rule belongs, and the action 845 taken at the service using the rule. For the gateway firewall, the action displays “Allow” indicating that the data message 325 was allowed at the gateway firewall. For the distributed firewall, the action displays “Reject” indicating that the data message 325 was rejected at the distributed firewall.

In some embodiments, the GUI 800 also displays a window 860 to display data messages related to the selected data messages. In this example, the window 860 displays data messages with the same source and destination IP addresses as the selected data message 325 and displays the services that were applied to those data messages as they traversed the network. The window 860 may display any information regarding additional data messages. The GUI 800 may also display a selectable item 870 for the user to select to close the GUI 800. Upon selection of this selectable item, the user may in some embodiments go back to viewing the GUI of FIG. 6.

In each of the windows 830 and 840, the GUI 800 may also display a selectable item 850. This selectable item 850, which may be labeled “View Changes” as in this example, enables a user to view modifications previously made to the service rule. Upon receiving a selection of this selectable item 850 for a particular service rule, another GUI is displayed to the user to display modifications previously made to the selected service rule. For example, selecting the selectable item 850 for the distributed firewall service window 840 will result in the GUI displaying any modifications made to the service rule made at the distributed firewall on the data message 325.

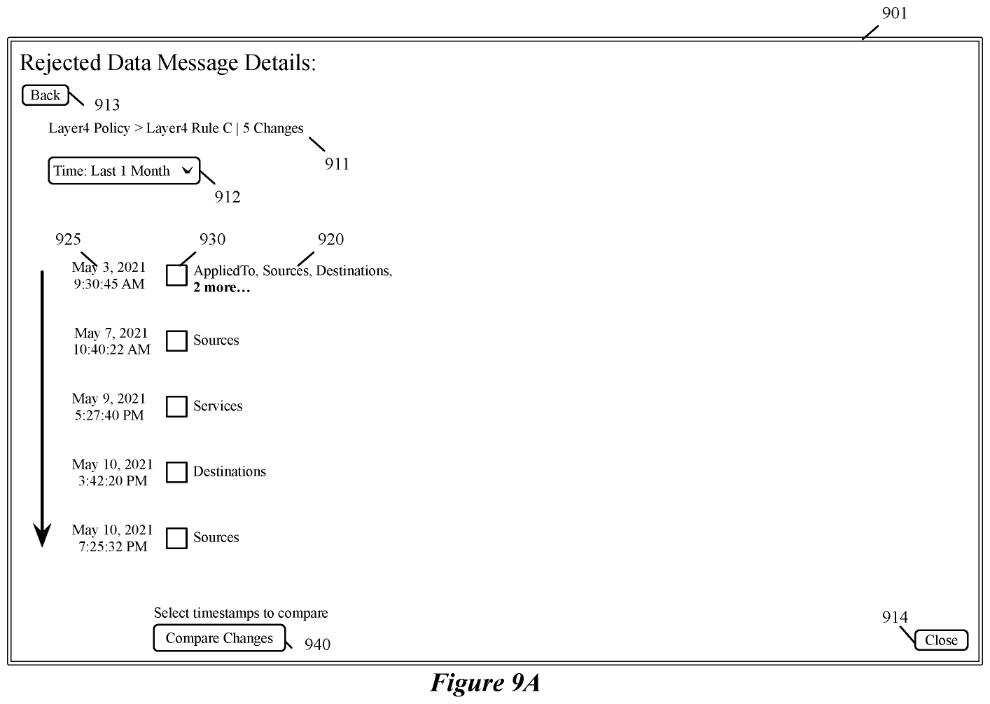

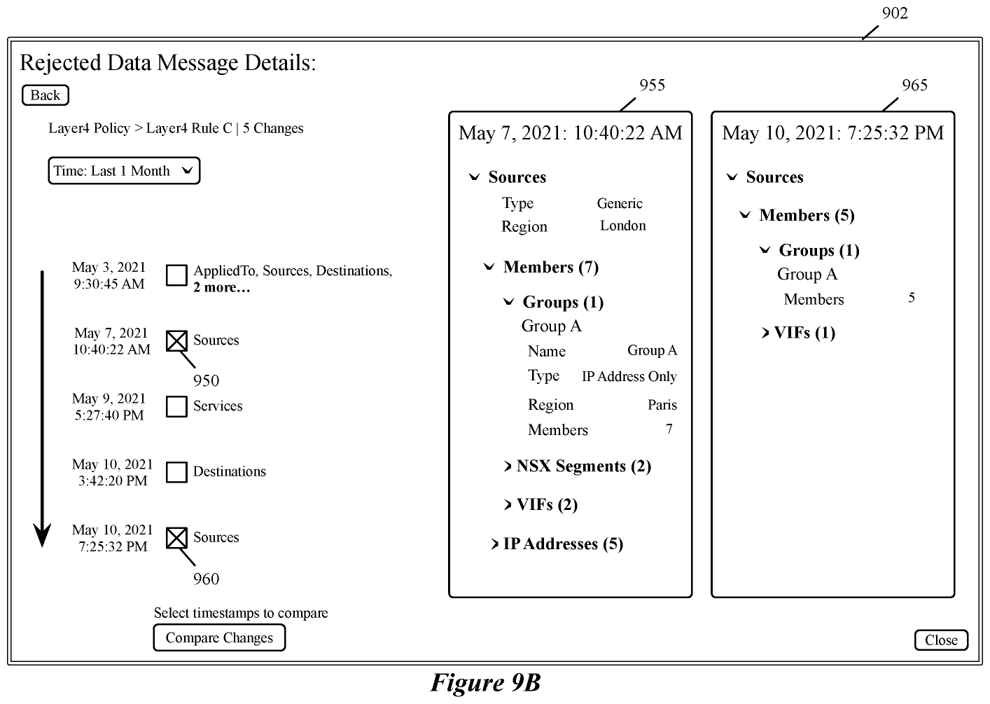

FIGS. 9A-B illustrate example GUIs 901 and 902 displaying information after user selection of the selectable item 850 for the service rule displayed in window 840. This GUI may display, for the selected service rule, the policy name, the rule name, and how many changes were made to this rule at 911. For the rule applied at the distributed firewall, the GUI 901 displays the policy name “Layer4 Policy” and the rule name “Layer4 Rule C,” and displays that five modifications, or changes, were made to this rule. The GUI may also display a selectable item 912 to filter a particular time period. For example, the selectable item 912 currently displays “Last 1 month” indicating that the GUI 901 is displaying all modifications made to the rule within the last month. A user may use this selectable item 912 to select any time period for which to view modifications made to the rule. Upon selection of a new time period, the GUI 901 may display more or less modifications made to the rule that were made within the newly selected time period. The GUI 901 may also display a “Back” selectable item 913 for the user to select to go back to the GUI 800. The GUI 901 may also display a selectable item 914 for the user to select to close this GUI 901. Upon selection of this selectable item, the user may in some embodiments go back to viewing the GUI of FIG. 6.

In some embodiments, the GUI 901 displays each of the modifications 920 made to the rule. In this example, five modifications were made to the rule, and each of those five modifications are displayed at 920. Timestamps 925 may also be displayed for each modification indicating when the modification was made to the service rule. Selectable items 930 may also be displayed for each modification. A user may select any one or more of these selectable items 930 to view the modifications made to the rule in more detail. A selectable item 940 may be included in the GUI 901 for the user to select to compare the selected modifications to the rule.

FIG. 9B illustrates the GUI 902 upon selection of modifications made to the rule. In this example, a user has selected two modifications 950 and 960 (as denoted by an “X” in both boxes) to view information regarding these modifications. The window 955 corresponds to the modification 950, and the window 965 corresponds to the modification 960. In each window, the timestamp for the modification may be displayed, along with additional information regarding the modification. A user may use this information to compare the two modifications 950 and 960 to the selected service rule applied to the data message 325 at the distributed firewall, which resulted in rejection of the data message 325.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

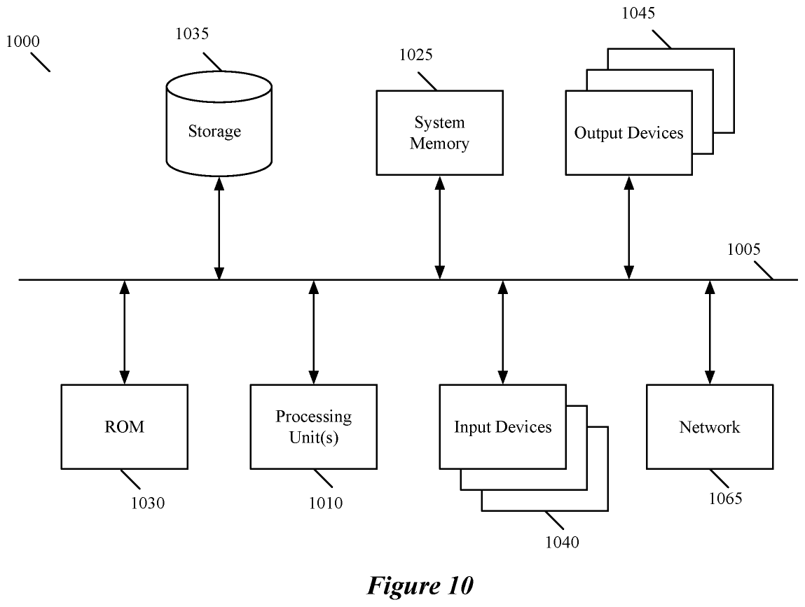

FIG. 10 conceptually illustrates a computer system 1000 with which some embodiments of the invention are implemented. The computer system 1000 can be used to implement any of the above-described computers and servers. As such, it can be used to execute any of the above described processes. This computer system includes various types of non-transitory machine readable media and interfaces for various other types of machine readable media. Computer system 1000 includes a bus 1005, processing unit(s) 1010, a system memory 1025, a read-only memory 1030, a permanent storage device 1035, input devices 1040, and output devices 1045.

The bus 1005 collectively represents all system, peripheral, and chipset buses that communicatively connect the numerous internal devices of the computer system 1000. For instance, the bus 1005 communicatively connects the processing unit(s) 1010 with the read-only memory 1030, the system memory 1025, and the permanent storage device 1035.

From these various memory units, the processing unit(s) 1010 retrieve instructions to execute and data to process in order to execute the processes of the invention. The processing unit(s) may be a single processor or a multi-core processor in different embodiments. The read-only-memory (ROM) 1030 stores static data and instructions that are needed by the processing unit(s) 1010 and other modules of the computer system. The permanent storage device 1035, on the other hand, is a read-and-write memory device. This device is a non-volatile memory unit that stores instructions and data even when the computer system 1000 is off. Some embodiments of the invention use a mass-storage device (such as a magnetic or optical disk and its corresponding disk drive) as the permanent storage device 1035.

Other embodiments use a removable storage device (such as a flash drive, etc.) as the permanent storage device. Like the permanent storage device 1035, the system memory 1025 is a read-and-write memory device. However, unlike storage device 1035, the system memory is a volatile read-and-write memory, such a random access memory. The system memory stores some of the instructions and data that the processor needs at runtime. In some embodiments, the invention's processes are stored in the system memory 1025, the permanent storage device 1035, and/or the read-only memory 1030. From these various memory units, the processing unit(s) 1010 retrieve instructions to execute and data to process in order to execute the processes of some embodiments.

The bus 1005 also connects to the input and output devices 1040 and 1045. The input devices enable the user to communicate information and select commands to the computer system. The input devices 1040 include alphanumeric keyboards and pointing devices (also called “cursor control devices”). The output devices 1045 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 10, bus 1005 also couples computer system 1000 to a network 1065 through a network adapter (not shown). In this manner, the computer can be a part of a network of computers (such as a local area network (“LAN”), a wide area network (“WAN”), or an Intranet, or a network of networks, such as the Internet. Any or all components of computer system 1000 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for visually depicting actions performed on data message flows in a network by a plurality of middlebox service elements in the network, the method comprising:
collecting, from a set of network elements, flow data comprising characteristics relating to a plurality of data message flows that traverse the network;
using the flow data to identify for each data message flow of the plurality of data message flows a set of middlebox services applied to the data message flow within the network;
generating an animated visualization of the data message flows, the animated visualization comprising a first plurality of representations of the middlebox services and a second plurality of representations of paths the data message flows take through the middlebox services, the animated visualization comprising at least two different heatmap representations for at least two different sets of data message flows to identify at least two different loads that the at least two different sets of data message flows exert on at least one middlebox service; and
providing the animated visualization in a graphical user interface (GUI) to enable monitoring of the plurality of data message flows traversing the network via different service paths.

2. The method of claim 1, wherein the animated visualization further comprises an animated heatmap that indicates (i) when a particular middlebox service is processing a high load of data message flows and (ii) when a high load of data message flows are sent on a particular path between a particular pair of middlebox services.

3. The method of claim 1, wherein:
the animated visualization is a visualization of data message flows that traverse the network over a particular period of time; and
the GUI comprises a selectable item enabling a user to modify the particular period of time.

4. The method of claim 3 further comprising, when the user selects a new period of time, generating a new animated visualization of the data message flows that traversed the network during the new period of time.

5. The method of claim 1, wherein:
the GUI comprises a set of filters for a user to select sets of data message flow characteristics; and
the method further comprises, upon selection of a set of data message flow characteristics via the set of filters, generating a new animated visualization comprising representations of only data message flows that match the selected set of data message flow characteristics.

6. The method of claim 5, wherein the sets of data message flow characteristics comprise one or more of a source address, a destination address, a source transport layer port number, a destination transport layer port number, and a transport layer protocol.

7. The method of claim 1, wherein the GUI comprises a set of selectable items for identifying for inclusion in the animated visualization one of (i) data message flows entering the network, (ii) data message flows exiting the network, and (iii) data message flows with sources and destinations within the network.

8. The method of claim 1, wherein the GUI animated visualization further comprises a third plurality of representations of actions performed by the middlebox services on the data message flows, the actions comprising one or more of (i) allowing data message flows, (ii) dropping data message flows, and (iii) blocking data message flows.

9. The method of claim 1, wherein the GUI further comprises, in addition to the animated visualization, a set of display areas for displaying a third plurality of representations of groups of data message flows having different sets of selectable characteristics.

10. The method of claim 9, wherein the set of display areas comprises separate display areas for each of (i) allowed data message flows, (ii) dropped data message flows, and (iii) blocked data message flows.

11. The method of claim 9, wherein:
the different sets of selectable characteristics comprise at least one of a source network address, a destination network address, a source transport layer port number, a destination transport layer port number, and a transport layer protocol; and
a user selects one or more selectable characteristics to for grouping data message flows within the set of display areas.

12. The method of claim 9, wherein each group of data message flows having a same set of values for the selected characteristics is represented using a selectable item.

13. The method of claim 12, wherein the selectable items vary in size based on a number of data message flows in the group represented by the selectable item.

14. The method of claim 12, wherein selection of one of the selectable items causes the GUI to display additional information about the group of data message flows represented by the selected selectable item.

15. The method of claim 14, wherein the additional information about the group comprises at least one of (i) a number of data message flows in the group, (ii) an action taken on each data message flow in the group, (iii) a source network address of each data message flow in the group, (iv) a destination network address of each data message flow in the group, (v) a source transport layer port number of each data message flow in the group, (iv) a destination transport layer port number of each data message flow in the group, and (vii) a transport layer protocol of each data message flow in the group.

16. A non-transitory machine-readable medium storing a program for execution by at least one processing unit for visually depicting actions performed on data message flows in a network by a plurality of middlebox service elements in the network, the program comprising sets of instructions for:
collecting, from a set of network elements, flow data comprising characteristics relating to a plurality of data message flows that traverse the network;
using the flow data to identify for each data message flow of the plurality of data message flows a set of middlebox services applied to the data message flow within the network;
generating an animated visualization of the data message flows, the animated visualization comprising a first plurality of representations of the middlebox services, a second plurality of representations of paths the data message flows take through the middlebox services, and a third plurality of representations of actions performed by the middlebox services on the data message flows, the third plurality of representations comprising concurrently displayed regions for each of at least two actions, each particular action's particular displayed region comprising a particular set of representations of data message flow groups (i) on which the particular action was performed by one or more middlebox services, and (ii) each having a different set of data message flow characteristics, wherein at least two different representations of at least two different data message flow groups are displayed with different sizes in one displayed region associated with one action in order to represent different numbers of data message flows in the at least two different data message flow groups; and
providing the animated visualization in a graphical user interface (GUI) to enable monitoring of the plurality of data message flows traversing the network via different service paths.

17. The non-transitory machine-readable medium of claim 16, wherein the animated visualization comprises an animated heatmap that indicates (i) when a particular middlebox service is processing a high load of data message flows and (ii) when a high load of data message flows are sent on a particular path between a particular pair of middlebox services.

18. The non-transitory machine-readable medium of claim 16, wherein:
the animated visualization is a visualization of data message flows that traverse the network over a particular period of time; and
the GUI comprises a selectable item enabling a user to modify the particular period of time.

19. The non-transitory machine-readable medium of claim 16, wherein:
the GUI comprises a set of filters for a user to select sets of data message flow characteristics; and
the program further comprises a set of instructions for generating, upon selection of a set of data message flow characteristics via the set of filters, a new animated visualization comprising a fourth plurality of representations of only data message flows that match the selected set of data message flow characteristics.

20. The non-transitory machine-readable medium of claim 16, wherein the set of network elements comprise at least one of (i) a set of one or more host computers in the network that are associated with the plurality of data message flows, and (ii) the plurality of middlebox service elements.

21. The non-transitory machine-readable medium of claim 20, wherein the concurrently displayed regions comprise separate display areas for each of (i) allowed data message flows, (ii) dropped data message flows, and (iii) blocked data message flows.

22. The non-transitory machine-readable medium of claim 16, wherein each data message flow group is represented using a selectable item.

23. The non-transitory machine-readable medium of claim 22, wherein selection of one of the selectable items causes the GUI to display additional information about the data message flow group represented by the selected selectable item.

24. The non-transitory machine-readable medium of claim 23, wherein the additional information about the data message flow group comprises at least one of (i) a number of data message flows in the data message flow group, (ii) an action taken on each data message flow in the data message flow group, (iii) a source network address of each data message flow in the data message flow group, (iv) a destination network address of each data message flow in the data message flow group, (v) a source transport layer port number of each data message flow in the data message flow group, (iv) a destination transport layer port number of each data message flow in the data message flow group, and (vii) a transport layer protocol of each data message flow in the data message flow group.
